(19) United States
(12) Patent Application Publication
(10) Pub. No.: US 2012/0236065 A1
(43) Pub. Date: Sep. 20, 2012

(54) Magnetic Curable Inks

(75) Inventors: Gabriel Iftime, Mississauga (CA); Naveen Chopra, Oakville (CA); Barkev Keoshkerian, Thornhill (CA); Peter G. Odell, Mississauga (CA)

(73) Assignee: XEROX CORPORATION, Norwalk, CT (US)

(21) Appl. No.: 13/050,403

(22) Filed: Mar. 17, 2011

(51) Int. Cl. B41J 2/015; C09D 11/10; B82Y 30/00

(52) U.S. Cl. 347/20; 252/62.54; 977/773; 977/902

(57) ABSTRACT

Disclosed is a curable magnetic ink comprising (a) an ink carrier which comprises at least one curable monomer, oligomer, or prepolymer; (b) at least one initiator; and (c) carbon-coated magnetic nanoparticles, said ink being curable upon exposure to radiation. Also disclosed is a process for printing with the ink.

### CROSS-REFERENCE TO RELATED APPLICATIONS

Reference is made to Copending application U.S. Ser. No. (not yet assigned; Xerox Docket No. 20100852-US-NP), filed concurrently herewith, entitled “Phase Change Magnetic Ink Comprising Carbon Coated Magnetic Nanoparticles and Process for Preparing Same,” with the named inventors Gabriel Iftime, C. Geoffrey Allen, Peter G. Odell, Richard P. N. Veregin, and Marcel P. Breton, the disclosure of which is totally incorporated herein by reference.

Reference is made to Copending application U.S. Ser. No. (not yet assigned; Xerox Docket No. 20100896-US-NP), filed concurrently herewith, entitled “Solvent Based Magnetic Ink Comprising Carbon Coated Magnetic Nanoparticles and Process for Preparing Same,” with the named inventors Gabriel Iftime, Peter G. Odell, C. Geoffrey Allen, Richard P. N. Veregin, Marcel P. Breton, and Gail Song, the disclosure of which is totally incorporated herein by reference.

Reference is made to Copending application U.S. Ser. No. (not yet assigned; Xerox Docket No. 20101179-US-NP), filed concurrently herewith, entitled “Phase Change Magnetic Ink Comprising Surfactant Coated Magnetic Nanoparticles and Process for Preparing Same,” with the named inventors Gabriel Iftime, Peter G. Odell, and Marcel P. Breton, the disclosure of which is totally incorporated herein by reference.

Reference is made to Copending application U.S. Ser. No. (not yet assigned; Xerox Docket No. 20101180-US-NP), filed concurrently herewith, entitled “Phase Change Magnetic Ink Comprising Coated Magnetic Nanoparticles and Process For Preparing Same,” with the named inventors Gabriel Iftime, Peter G. Odell, and Marcel P. Breton, the disclosure of which is totally incorporated herein by reference.

Reference is made to Copending application U.S. Ser. No. (not yet assigned; Xerox Docket No. 20101181-US-NP), filed concurrently herewith, entitled “Phase Change Magnetic Ink Comprising Polymer Coated Magnetic Nanoparticles and Process for Preparing Same,” with the named inventors Gabriel Iftime, Peter G. Odell, and Marcel P. Breton, the disclosure of which is totally incorporated herein by reference.

Reference is made to Copending application U.S. Ser. No. (not yet assigned; Xerox Docket No. 20101182-US-NP), filed concurrently herewith, entitled “Phase Change Magnetic Ink Comprising Inorganic Oxide Coated Magnetic Nanoparticles and Process for Preparing Same,” with the named inventors Gabriel Iftime, Peter G. Odell, and Marcel P. Breton, the disclosure of which is totally incorporated herein by reference.

Reference is made to Copending application U.S. Ser. No. (not yet assigned; Xerox Docket No. 20101215-US-NP), filed concurrently herewith, entitled “Curable Inks Comprising Inorganic Oxide-Coated Magnetic Nanoparticles,” with the named inventors Gabriel Iftime, Naveen Chopra, Barkev Keoshkerian, Peter G. Odell, and Marcel P. Breton, the disclosure of which is totally incorporated herein by reference.

Reference is made to Copending application U.S. Ser. No. (not yet assigned; Xerox Docket No. 20101216-US-NP), filed concurrently herewith, entitled “Curable Inks Comprising Polymer-Coated Magnetic Nanoparticles,” with the named inventors Gabriel Iftime, Naveen Chopra, Barkev Keoshkerian, Peter G. Odell, and Marcel P. Breton, the disclosure of which is totally incorporated herein by reference.

Reference is made to Copending application U.S. Ser. No. (not yet assigned; Xerox Docket No. 20101217-US-NP), filed concurrently herewith, entitled “Curable Inks Comprising Coated Magnetic Nanoparticles,” with the named inventors Gabriel Iftime, Naveen Chopra, Barkev Keoshkerian, Peter G. Odell, and Marcel P. Breton, the disclosure of which is totally incorporated herein by reference.

Reference is made to Copending application U.S. Ser. No. (not yet assigned; Xerox Docket No. 20101218-US-NP, filed concurrently herewith, entitled “Curable Inks Comprising Surfactant-Coated Magnetic Nanoparticles,” with the named inventors Gabriel Iftime, Naveen Chopra, Barkev Keoshkerian, Peter G. Odell, and Marcel P. Breton, the disclosure of which is totally incorporated herein by reference.

Reference is made to Copending application U.S. Ser. No. (not yet assigned; Xerox Docket No. 20101344-US-NP), filed concurrently herewith, entitled “Solvent-Based Inks Comprising Coated Magnetic Nanoparticles,” with the named inventors Gabriel Iftime, Peter G. Odell, Geoff Allen, Marcel P. Breton, and Richard P. N. Veregin, the disclosure of which is totally incorporated herein by reference.

Reference is made to Copending application U.S. Ser. No. (not yet assigned; Xerox Docket No. 20101347-US-NP), filed concurrently herewith, entitled “Solvent-Based Inks Comprising Coated Magnetic Nanoparticles,” with the named inventors Gabriel Iftime, Peter G. Odell, C. Geoffrey Allen, Marcel P. Breton, and Richard P. N. Veregin, the disclosure of which is totally incorporated herein by reference.

### BACKGROUND

Disclosed herein are curable inks and methods for the use thereof. More specifically, disclosed herein are curable inks containing magnetic nanoparticles.

Non digital inks and printing elements suitable for MICR printing are known. The two most known technologies are ribbon based thermal printing systems and offset technology. For example, U.S. Pat. No. 4,463,034 discloses heat sensitive magnetic transfer element for printing MICR, comprising a heat resistant foundation and a heat sensitive imaging layer. The imaging layer is made of ferromagnetic substance dispersed in a wax and is transferred on a receiving paper in the form of magnetic image by a thermal printer which uses a ribbon.

U.S. Pat. No. 5,866,637 discloses formulations and ribbons which employ wax, binder resin, and organic molecule based magnets which are to be employed for use with a thermal printer which employs a ribbon.

MICR inks suitable for offset printing using a numbering box are typically thick, highly concentrated pastes containing for example over about 60% magnetic metal oxides dispersed in a base containing soy based varnishes. Such inks are for example commercially available at Heath Custom Press (Auburn, Wash.).

Digital water-based ink-jet inks composition for MICR applications using a metal oxide based ferromagnetic particles of a particle size of less than 500 microns are disclosed in U.S. Pat. No. 6,767,396. Water based inks are commercially available from Diversified Nano Corporation (San Diego, Calif.).

Curable inks generally comprise at least one curable monomer, a colorant, and a radiation activated initiator that initiates polymerization of curable components of the ink. Curable inks can be employed in ink jet printing systems. Curable inks are known as well, as disclosed in, for example, U.S. Pat. Nos. 7,153,349, 7,259,275, 7,270,408, 7,271,284, 7,276,614, 7,279,506, 7,279,587, 7,293,868, 7,317,122, 7,323,498, 7,384,463, 7,449,515, 7,459,014, 7,531,582, 7,538,145, 7,541,406, 7,553,011, 7,556,844, 7,559,639, 7,563,489, 7,578,587, 7,625,956, 7,632,546, 7,674,842, 7,681,966, 7,683,102, 7,690,782, 7,691,920, 7,699,922, 7,714,040, 7,754,779, 7,812,064, and 7,820,731, the disclosures of each of which are totally incorporated herein by reference. Curable inks can exhibit desirable characteristics such as improved hardness and scratch-resistance and improved adhesion to various substrates. Curable gel inks can also exhibit advantages in that dot spread of the ink can be controlled and the ink does not bleed excessively into the substrate.

Magnetic inks in general are known. For example, ferromagnetic inks become magnetized by a magnet and maintain some fraction of the saturation magnetization once the magnet is removed. These inks are known for magnetic ink character recognition (MICR) applications such as automated check processing. In addition, superparamagnetic inks are also magnetized in the presence of a magnetic field, but lose their magnetization in the absence of a magnetic field. These inks are known for security printing applications, wherein a metal detecting device is used for authenticating the magnetic metal property of secure prints made with the ink as disclosed in, for example, U.S. Pat. No. 5,667,924, the disclosure of which is totally incorporated herein by reference.

### SUMMARY

Disclosed herein is a curable magnetic ink comprising: (a) an ink carrier which comprises at least one curable monomer, oligomer, or prepolymer; (b) at least one initiator; and (c) carbon-coated magnetic nanoparticles; said ink being curable upon exposure to radiation. Also disclosed herein is a process which comprises: (1) incorporating into an ink jet printing apparatus a curable magnetic ink comprising: (a) an ink carrier which comprises at least one curable monomer, oligomer, or prepolymer; (b) at least one initiator; (c) carbon-coated magnetic nanoparticles, said ink being curable upon exposure to radiation; (2) melting the ink; (3) causing droplets of the melted ink to be ejected in an imagewise pattern onto a substrate; and (4) exposing the imagewise pattern to curing radiation.

### DETAILED DESCRIPTION

The inks disclosed herein are curable. By “curable” is meant that the ink carriers comprise at least one compound that is polymerizable or chain extendable, i.e., a material that can be cured via polymerization, including (but not limited to) free radical polymerization or chain extension, cationic polymerization or chain extension, and/or in which polymerization is photoinitiated through use of a radiation sensitive photoinitiator. Radiation curable as used herein is intended to cover all forms of curing upon exposure to a radiation source, including (but not limited to) light and heat sources and including in the presence or absence of initiators. Examples of radiation curing include (but are not limited to) ultraviolet (UV) light, for example having a wavelength of from about 200 to about 400 nanometers, visible light, or the like, optionally in the presence of photoinitiators and/or sensitizers, e-beam radiation, optionally in the presence of photoinitiators, thermal curing, optionally in the presence of high temperature thermal initiators (and which are preferably largely inactive at the jetting temperature when used in phase change inks), and appropriate combinations thereof.

Examples of suitable curable monomers, oligomers, and prepolymers include (but are not limited to) propoxylated neopentyl diacrylate, such as SR9003, commercially available from Sartomer Co. Inc., Exton, Pa., isobornyl acrylate, isobornyl methacrylate, lauryl acrylate, lauryl methacrylate, isodecylacrylate, isodecylmethacrylate, caprolactone acrylate, 2-phenoxyethyl acrylate, isooctylacrylate, isooctylmethacrylate, butyl acrylate, EBECRYL 812 polyester acrylate oligomer, available from Cytec Corp. (Woodland Park, N.J.), and the like, as well as mixtures thereof. Examples of suitable multifunctional acrylate and methacrylate monomers, oligomers, and polymers include (but are not limited to) pentaerythritol tetraacrylate, pentaerythritol tetramethacrylate, propoxylated neopentylglycol diacrylate, 1,2-ethylene glycol diacrylate, 1,2-ethylene glycol dimethacrylate, 1,6-hexanediol diacrylate, 1,6-hexanediol dimethacrylate, alkoxylated hexanediol diacrylate, tricyclodecane dimethanol diacrylate, 1,12-dodecanol diacrylate, 1,12-dodecanol dimethacrylate, tris(2-hydroxy ethyl)isocyanurate triacrylate, hexanediol diacrylate, tripropylene glycol diacrylate, dipropylene glycol diacrylate, amine modified polyether acrylates (available as PO 83F, PO 94F, LR 8869, and/or LR 8889 (all available from BASF Corporation, Charlotte, N.C.), trimethylolpropane triacrylate, glycerol propoxylate triacrylate, dipentaerythritol pentaacrylate, dipentaerythritol hexaacrylate, ethoxylated pentaerythritol tetraacrylate (available from Sartomer Co. Inc. as SR 494), and the like, as well as mixtures thereof.

The reactive monomer, oligomer, or prepolymer is present in the ink in any desired or effective amount, in one embodiment at least about 20% by weight of the ink carrier, in another embodiment at least about 30% by weight of the ink carrier, and in yet another embodiment at least about 40% by weight of the ink carrier, and in one embodiment no more than about 90% by weight of the ink carrier, in another embodiment no more than about 85% by weight of the ink carrier, and in yet another embodiment no more than about 80% by weight of the ink carrier, although the amount can be outside of these ranges.

When a reactive diluent is added to the ink carrier, the reactive diluent is added in any desired or effective amount, in one embodiment at least about 1% by weight of the carrier, and in another embodiment at least about 35% by weight of the carrier, and in one embodiment no more than about 80% by weight of the carrier, and in another embodiment no more than about 70% by weight of the carrier, although the amount of diluent can be outside of these ranges.

The ink carrier can also optionally contain a gellant material. Gellants can be used to effect a rapid viscosity increase in the jetted ink upon the substrate. In particular, jetted ink droplets can be pinned into position on a receiving substrate such as a final recording substrate, such as paper or transparency material, or an intermediate transfer member, such as a transfuse drum or belt, that is maintained at a temperature cooler than the ink jetting temperature of the ink through the action of a phase change transition in which the ink undergoes a significant viscosity change from a liquid state to a gel state (or semi-solid state). Accordingly, dot spread can be achieved, particularly on porous substrates, and excessive bleeding of the ink into the substrate can be reduced or eliminated. Showthrough of the image to the reverse side of the substrate can also be reduced or eliminated.

The gellant can function to increase dramatically the viscosity of the radiation curable ink within a desired temperature range. In particular, the gellant can form a semi-solid gel in the ink carrier at temperatures below the specific temperature at which the ink is jetted. The semi-solid gel phase in a specific embodiment is a physical gel that exists as a dynamic equilibrium comprising one or more solid gellant molecules and a liquid solvent. The semi-solid gel phase is believed to be a dynamic networked assembly of molecular components held together by non-covalent bonding interactions such as hydrogen bonding, Van der Waals interactions, aromatic non-bonding interactions, ionic or coordination bonding, London dispersion forces, or the like, which upon stimulation by physical forces such as temperature or mechanical agitation or chemical forces such as pH or ionic strength, can undergo a reversible transition from liquid to semi-solid state at the macroscopic level. The inks exhibit a thermally reversible transition between the semi-solid gel state and the liquid state when the temperature is varied above or below the gel phase transition of the ink. This reversible cycle of transitioning between semi-solid gel phase and liquid phase can be repeated many times in the ink formulation. Mixtures of one or more gellants can be used to effect the phase-change transition.

Examples of suitable gellant materials include (but are not limited to) curable amide gellants as disclosed in U.S. Pat. No. 7,714,040, the disclosure of which is totally incorporated herein by reference, such as those of the formula

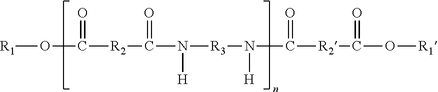

wherein:

R₁ and R₁′ each, independently of the other, are: (i) an alkyl group, (ii) an arylalkyl group, or (iii) an alkylaryl group; R₂ and R₂′ each, independently of the other, are: (i) alkylene groups, (ii) arylene groups, (iii) arylalkylene groups, or (iv) alkylarylene groups; R₃ is: (i) an alkylene group, (ii) an arylene group, (iii) an arylalkylene group, or (iv) an alkylarylene group; and n is an integer representing the number of repeat amide units, being in one embodiment at least 1, and in one embodiment no more than about 20, in another embodiment no more than about 15, and in yet another embodiment no more than about 10, although the value of n can be outside of these ranges.

Also suitable as gellants are diamide compounds as described in U.S. Pat. Nos. 7,276,614 and 7,279,587, the disclosures of which are totally incorporated herein by reference. As described in U.S. Pat. No. 7,279,587, the amide gellant can be a compound of the formula

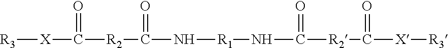

wherein:

R₁ is:

(i) an alkylene group (wherein an alkylene group is defined as a divalent aliphatic group or alkyl group, including linear and branched, saturated and unsaturated, cyclic and acyclic, and substituted and unsubstituted alkylene groups, and wherein hetero atoms, such as oxygen, nitrogen, sulfur, silicon, phosphorus, boron, and the like either may or may not be present in the alkylene group), in one embodiment with at least 1 carbon atom, and in one embodiment with no more than about 12 carbon atoms, in another embodiment with no more than about 4 carbon atoms, and in yet another embodiment with no more than about 2 carbon atoms, although the number of carbon atoms can be outside of these ranges,

(ii) an arylene group (wherein an arylene group is defined as a divalent aromatic group or aryl group, including substituted and unsubstituted arylene groups, and wherein hetero atoms, such as oxygen, nitrogen, sulfur, silicon, phosphorus, boron, and the like either may or may not be present in the arylene group), in one embodiment with at least about 5 carbon atoms, and in another embodiment with at least about 6 carbon atoms, and in one embodiment with no more than about 14 carbon atoms, in another embodiment with no more than about 10 carbon atoms, and in yet another embodiment with no more than about 6 carbon atoms, although the number of carbon atoms can be outside of these ranges,

(iii) an arylalkylene group (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein hetero atoms, such as oxygen, nitrogen, sulfur, silicon, phosphorus, boron, and the like either may or may not be present in either the aryl or the alkyl portion of the arylalkylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 7 carbon atoms, although the number of carbon atoms can be outside of these ranges, or

(iv) an alkylarylene group (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein hetero atoms, such as oxygen, nitrogen, sulfur, silicon, phosphorus, boron, and the like either may or may not be present in either the aryl or the alkyl portion of the alkylarylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 7 carbon atoms, although the number of carbon atoms can be outside of these ranges, wherein the substituents on the substituted alkylene, arylene, arylalkylene, and alkylarylene groups can be (but are not limited to) halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein two or more substituents can be joined together to form a ring;

R₂ and R₂′ each, independently of the other, are:

(i) alkylene groups (wherein an alkylene group is defined as a divalent aliphatic group or alkyl group, including linear and branched, saturated and unsaturated, cyclic and acyclic, and substituted and unsubstituted alkylene groups, and wherein hetero atoms, such as oxygen, nitrogen, sulfur, silicon, phosphorus, boron, and the like either may or may not be present in the alkylene group), in one embodiment with at least 1 carbon atom, and in one embodiment with no more than about 54 carbon atoms, and in another embodiment with no more than about 36 carbon atoms, although the number of carbon atoms can be outside of these ranges,

(ii) arylene groups (wherein an arylene group is defined as a divalent aromatic group or aryl group, including substituted and unsubstituted arylene groups, and wherein hetero atoms, such as oxygen, nitrogen, sulfur, silicon, phosphorus, boron, and the like either may or may not be present in the arylene group), in one embodiment with at least about 5 carbon atoms, and in another embodiment with at least about 6 carbon atoms, and in one embodiment with no more than about 14 carbon atoms, in another embodiment with no more than about 10 carbon atoms, and in yet another embodiment with no more than about 7 carbon atoms, although the number of carbon atoms can be outside of these ranges,

(iii) arylalkylene groups (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein hetero atoms, such as oxygen, nitrogen, sulfur, silicon, phosphorus, boron, and the like either may or may not be present in either the aryl or the alkyl portion of the arylalkylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 8 carbon atoms, although the number of carbon atoms can be outside of these ranges, or

(iv) alkylarylene groups (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein hetero atoms, such as oxygen, nitrogen, sulfur, silicon, phosphorus, boron, and the like either may or may not be present in either the aryl or the alkyl portion of the alkylarylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 7 carbon atoms, although the number of carbon atoms can be outside of these ranges, wherein the substituents on the substituted alkylene, arylene, arylalkylene, and alkylarylene groups can be (but are not limited to) halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, wherein two or more substituents can be joined together to form a ring;

R₃ and R₃′ each, independently of the other, are either:

(a) photoinitiating groups, such as groups derived from 1-(4-(2-hydroxyethoxy)phenyl)-2-hydroxy-2-methylpropan-1-one, of the formula

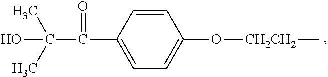

groups derived from 1-hydroxycyclohexylphenylketone, of the formula

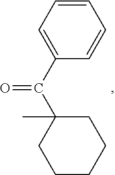

groups derived from 2-hydroxy-2-methyl-1-phenylpropan-1-one, of the formula

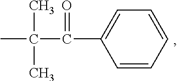

groups derived from N,N-dimethylethanolamine or N,N-dim ethylethylenediamine, of the formula

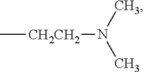

or the like, or:

(b) a group which is:

(i) an alkyl group (including linear and branched, saturated and unsaturated, cyclic and acyclic, and substituted and unsubstituted alkyl groups, and wherein hetero atoms, such as oxygen, nitrogen, sulfur, silicon, phosphorus, boron, and the like either may or may not be present in the alkyl group), in one embodiment with at least about 2 carbon atoms, in another embodiment with at least about 3 carbon atoms, and in yet another embodiment with at least about 4 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges,

(ii) an aryl group (including substituted and unsubstituted aryl groups, and wherein hetero atoms, such as oxygen, nitrogen, sulfur, silicon, phosphorus, boron, and the like either may or may not be present in the aryl group), in one embodiment with at least about 5 carbon atoms, and in another embodiment with at least about 6 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, such as phenyl or the like,

(iii) an arylalkyl group (including substituted and unsubstituted arylalkyl groups, wherein the alkyl portion of the arylalkyl group can be linear or branched, saturated or unsaturated, and cyclic or acyclic, and wherein hetero atoms, such as oxygen, nitrogen, sulfur, silicon, phosphorus, boron, and the like either may or may not be present in either the aryl or the alkyl portion of the arylalkyl group), in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, such as benzyl or the like, or

(iv) an alkylaryl group (including substituted and unsubstituted alkylaryl groups, wherein the alkyl portion of the alkylaryl group can be linear or branched, saturated or unsaturated, and cyclic or acyclic, and wherein hetero atoms, such as oxygen, nitrogen, sulfur, silicon, phosphorus, boron, and the like either may or may not be present in either the aryl or the alkyl portion of the alkylaryl group), in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, such as tolyl or the like, wherein the substituents on the substituted alkyl, arylalkyl, and alkylaryl groups can be (but are not limited to) halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring;

provided that at least one of R₃ and R₃′ is a photoinitiating group;

and X and X′ each, independently of the other, is an oxygen atom or a group of the formula —NR₄—, wherein R₄ is:

(i) a hydrogen atom;

(ii) an alkyl group, including linear and branched, saturated and unsaturated, cyclic and acyclic, and substituted and unsubstituted alkyl groups, and wherein hetero atoms either may or may not be present in the alkyl group, in one embodiment with at least 1 carbon atom, and in one embodiment with no more than about 100 carbon atoms, in another embodiment with no more than about 60 carbon atoms, and in yet another embodiment with no more than about 30 carbon atoms, although the number of carbon atoms can be outside of these ranges,

(iii) an aryl group, including substituted and unsubstituted aryl groups, and wherein hetero atoms either may or may not be present in the aryl group, in one embodiment with at least about 5 carbon atoms, and in another embodiment with at least about 6 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges,

(iv) an arylalkyl group, including substituted and unsubstituted arylalkyl groups, wherein the alkyl portion of the arylalkyl group can be linear or branched, saturated or unsaturated, and cyclic or acyclic, and wherein hetero atoms either may or may not be present in either the aryl or the alkyl portion of the arylalkyl group, in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, or

(v) an alkylaryl group, including substituted and unsubstituted alkylaryl groups, wherein the alkyl portion of the alkylaryl group can be linear or branched, saturated or unsaturated, and cyclic or acyclic, and wherein hetero atoms either may or may not be present in either the aryl or the alkyl portion of the alkylaryl group, in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, wherein the substituents on the substituted alkyl, aryl, arylalkyl, and alkylaryl groups can be (but are not limited to) halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring.

Specific examples of these compounds include

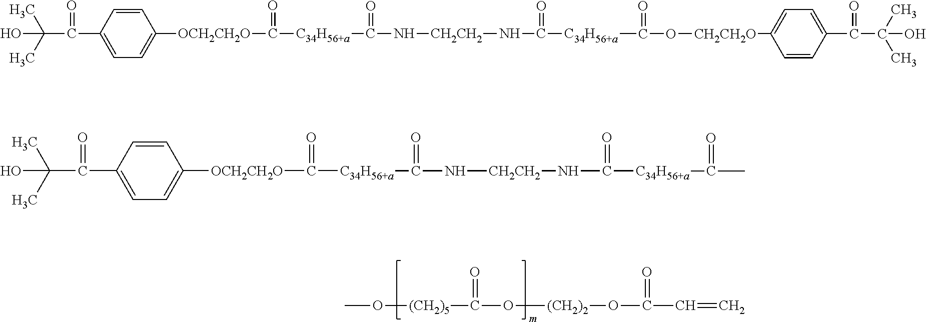

wherein m is an integer, including but not limited to embodiments wherein m is 2,

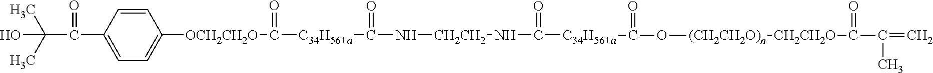

wherein n is an integer, including but not limited to embodiments wherein n is 2 and wherein n is 5,

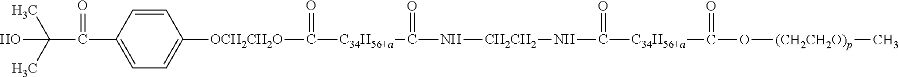

wherein p is an integer, including but not limited to embodiments wherein p is 2 and wherein p is 3,

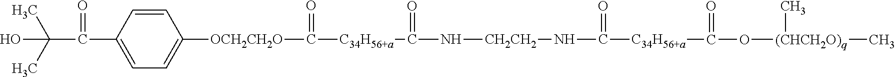

wherein q is an integer, including but not limited to embodiments wherein q is 2 and wherein q is 3,

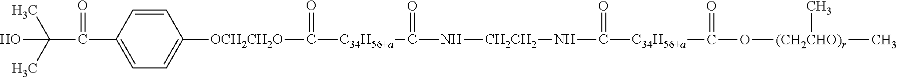

wherein r is an integer, including but not limited to embodiments wherein r is 2 and wherein r is 3, and the like, as well as mixtures thereof, in each instance of which —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12, including (but not limited to) isomers of the formula

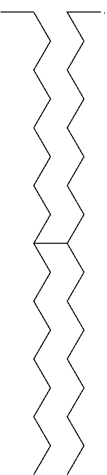

Also suitable as gellants are aromatic ester-terminated diamide compounds of the formula

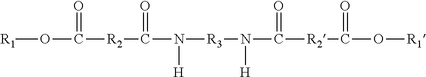

wherein R₁ and R₁′ can be the same or different and wherein R₁ and R₁′ each, independently of the other, can be groups such as

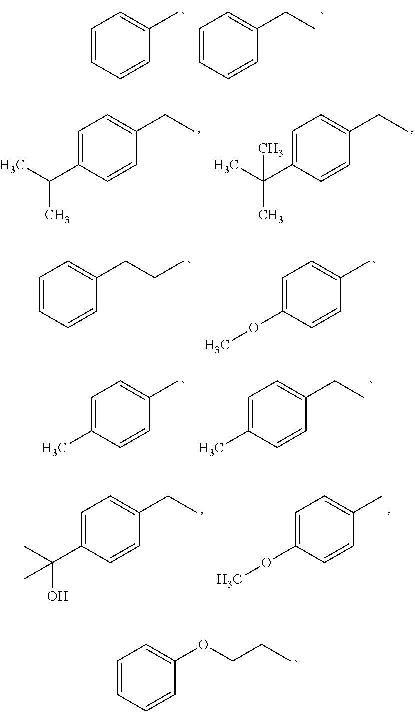

R₂ and R₂′ include groups such as isomers of the formula —C₃₄H₅₆₊ₐ— which are branched alkylene groups which may include unsaturations and cyclic groups, wherein a is an integer of 0, 1, 2, 3, 4, 5, 6, 7, 8, 9, 10, 11, or 12, and R₃ includes groups such as —CH₂CH₂—, as disclosed in, for example, U.S. application Ser. No. 12/765,148, filed Apr. 22, 2010, entitled “Amide Gellant Compounds with Aromatic End Groups,” with the named inventors Naveen Chopra, Michelle N. Chrétien, Barkev Keoshkerian, Jennifer L. Belelie, and Peter G. Odell, the disclosure of which is totally incorporated herein by reference, such as those of the formula

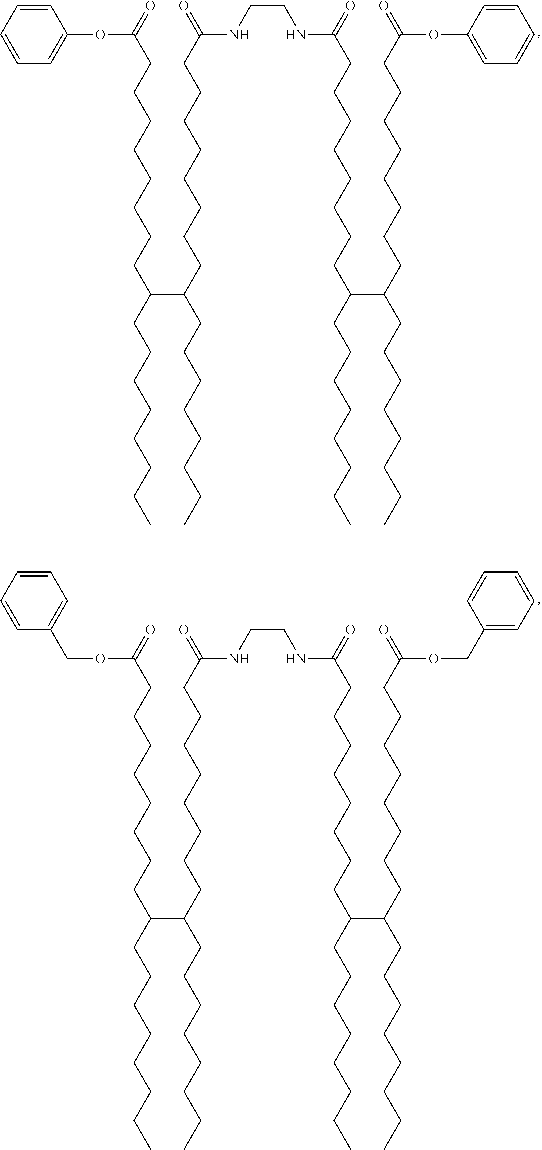

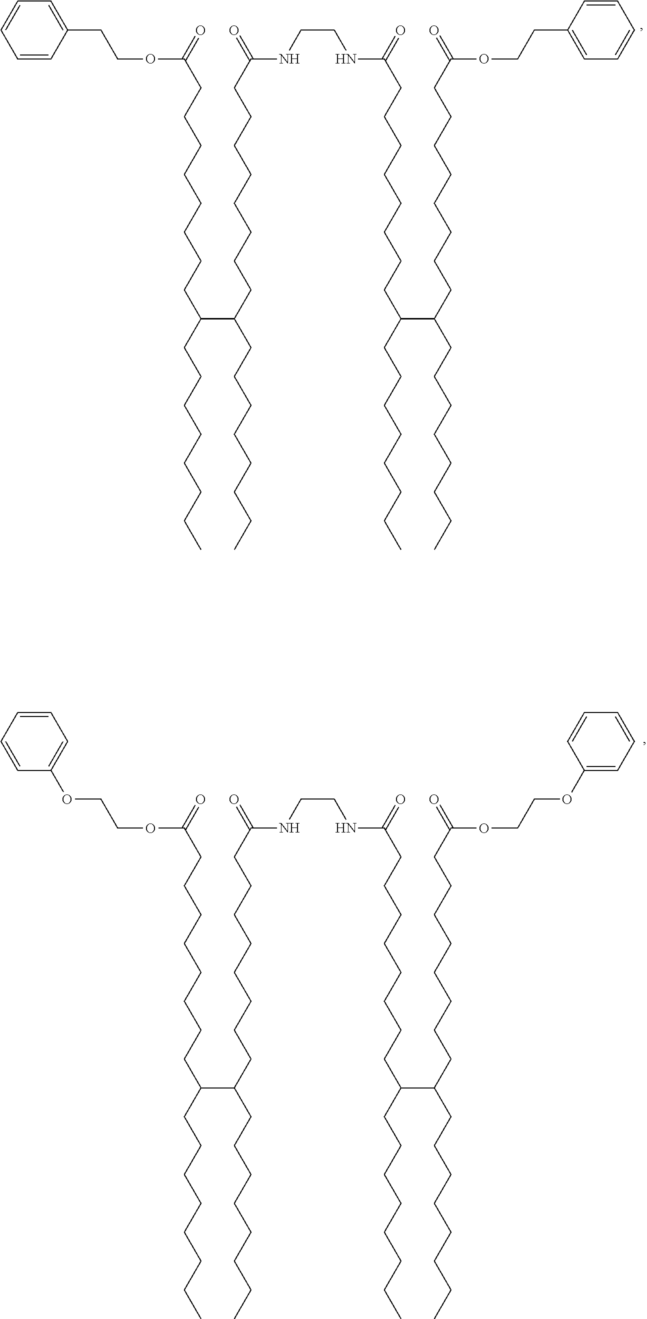

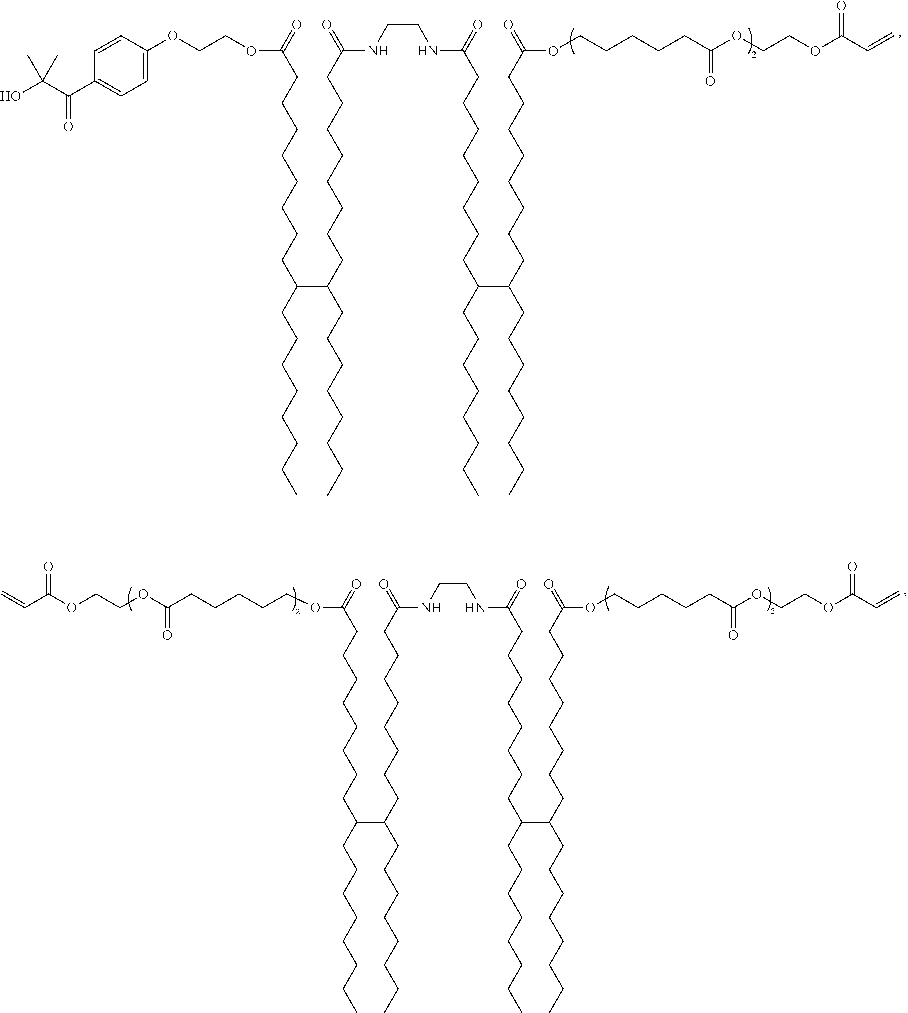

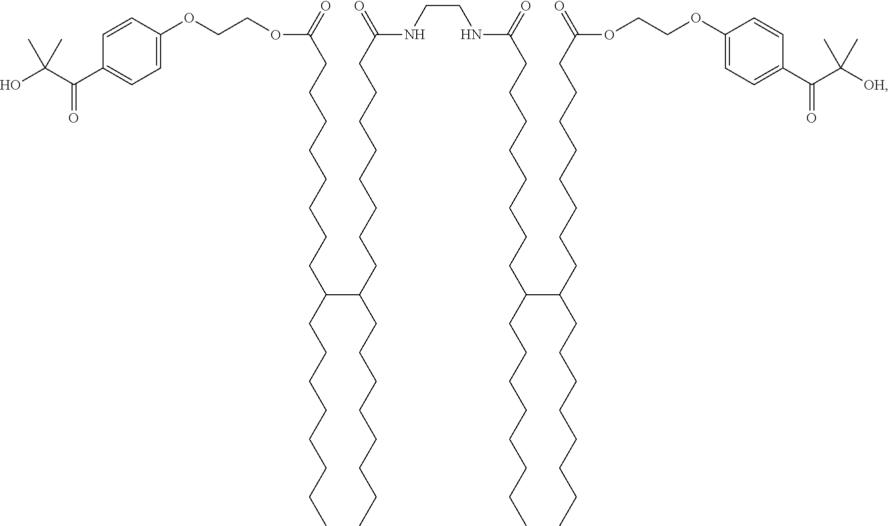

and the like, as well as mixtures thereof.

Also suitable as gellants are trans-1,2-cyclohexane bis(urea-urethane) compounds as disclosed in, for example, U.S. Pat. No. 7,153,349, the disclosure of which is totally incorporated herein by reference, such as those

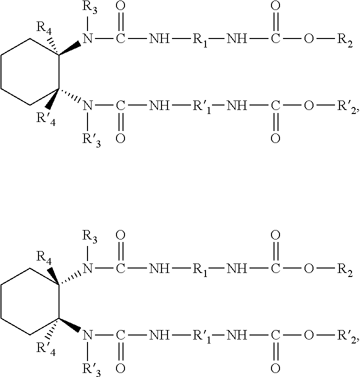

or mixtures thereof, wherein R₁ and R′₁ each, independently of the other, is (i) an alkylene group, (ii) an arylene group, (iii) an arylalkylene group, or (iv) an alkylarylene group, R₂ and R′₂ each, independently of the other, is (i) an alkyl group, (ii) an aryl group, (iii) an arylalkyl group, or (iv) an alkylaryl group, R₃ and R′₃ each, independently of the other, is a hydrogen atom or an alkyl group, R₄ and R′₄ each, independently of the other, is a hydrogen atom, a fluorine atom, an alkyl group, or a phenyl group, n is an integer of 0, 1 2, 3, or 4, and each R₅, independently of the others, is (i) an alkyl group, (ii) an aryl group, (iii) an arylalkyl group, (iv) an alkylaryl group, or (v) a substituent other than an alkyl, aryl, arylalkyl, or alkylaryl group, wherein the substituents on the substituted alkyl, alkylene, aryl, arylene, arylalkyl, arylalkylene, alkylaryl, and alkylarylene groups and the substituents other than alkyl, aryl, arylalkyl, or alkylaryl groups can be (but are not limited to) halogen atoms, including fluorine, chlorine, bromine, and iodine atoms, imine groups, ammonium groups, cyano groups, pyridinium groups, ether groups, aldehyde groups, ketone groups, ester groups, carbonyl groups, thiocarbonyl groups, sulfide groups, sulfoxide groups, phosphine groups, nitrile groups, mercapto groups, nitro groups, nitroso groups, sulfone groups, acyl groups, urethane groups, urea groups, mixtures thereof, and the like, wherein two or more substituents can be joined together to form a ring.

When present, the gellant is present in the ink in any desired or effective amount, in one embodiment at least about 5% by weight of the ink carrier, in another embodiment at least about 7.5% by weight of the ink carrier, and in yet another embodiment at least about 10% by weight of the ink carrier, and in one embodiment no more than about 50% by weight of the ink carrier, in another embodiment no more than about 40% by weight of the ink carrier, and in yet another embodiment no more than about 30% by weight of the ink carrier, although the amount can be outside of these ranges.

One or more waxes can optionally be added to the ink. In some embodiments, waxes can raise the image density and can prevent image smearing. Examples of suitable waxes include, but are not limited to, polyolefin waxes, such as low molecular weight polyethylene and polypropylene and copolymers thereof, Fischer-Tropsch waxes, fluorocarbon-based waxes such as Teflon, and the like, as well as mixtures thereof. The wax can be present in any desired or effective amount, in one embodiment at least about 0.1% by weight of the ink, and in another embodiment at least about 1% by weight of the ink, and in one embodiment no more than about 10% by weight of the ink, and in another embodiment no more than about 6% by weight of the ink, although the amount can be outside of these ranges.

In one specific embodiment the wax can be a curable wax. The curable wax can be synthesized by the reaction of a wax containing a transformable functional group, such as carboxylic acid or hydroxyl, with a reagent containing curable or polymerizable groups. Suitable examples of waxes containing hydroxyl groups include hydroxyl-terminated polyethylene waxes and Guerbet alcohols (which are characterized as 2,2-dialkyl-1-ethanols). Suitable waxes containing carboxylic acid transformable group include carboxylic acid terminated polyethylenes and Guerbet acids (which are characterized as 2,2-dialkyl ethanoic acids). The curable groups present can include, but are not limited to, acrylate, methacrylate, alkene, alkyne, vinyl, and allylic ether. Examples of suitable curable waxes are the reaction products of compounds of the formula CH₃(CH₂)ₙ—CH₂OH, wherein n is an integer representing the number of repeat CH₂ groups, with acrylic acid or methacrylic acid.

The curable wax can be present in the ink in any desired or effective amount, in one embodiment at least about 1%, in another embodiment at least about 2%, and in yet another embodiment at least about 3%, and in one embodiment no more than about 40%, in another embodiment no more than about 30%, and in yet another embodiment no more than about 20%, by weight of the ink carrier, although the amounts can be outside of these ranges.

The ink carrier is present in the ink in any desired or effective amount, in one embodiment of at least about 0.1% by weight of the ink, in another embodiment of at least about 50% by weight of the ink, in yet another embodiment of at least about 70% by weight of the ink, and in still another embodiment of at least about 90% by weight of the ink, and in one embodiment of no more than about 97% by weight of the ink, in another embodiment of no more than about 95% by weight of the ink, and in yet another embodiment of no more than about 85% by weight of the ink, although the amount can be outside of these ranges.

The ink compositions further comprise an initiator. Examples of free radical initiators include benzyl ketones, monomeric hydroxyl ketones, polymeric hydroxyl ketones, α-amino ketones, acyl phosphine oxides, metallocenes, benzophenone, benzophenone derivatives, and the like. Specific examples include 1-hydroxy-cyclohexylphenylketone, benzophenone, 2-benzyl-2-(dimethylamino)-1-(4-(4-morphorlinyl)phenyl)-1-butanone, 2-methyl-1-(4-methylthio)phenyl-2-(4-morphorlinyl)-1-propanone, diphenyl-(2,4,6-trimethylbenzoyl)phosphine oxide, phenyl bis(2,4,6-trimethylbenzoyl)phosphine oxide, benzyl-dimethylketal, isopropylthioxanthone (DAROCUR ITX, available from BASF), 2,4,6-trimethylbenzoyldiphenylphosphine oxide (available as BASF LUCIRIN TPO), 2,4,6-trimethylbenzoylethoxyphenylphosphine oxide (available as BASF LUCIRIN TPO-L), bis(2,4,6-trimethylbenzoyl)-phenyl-phosphine oxide (available from BASF as IRGACURE 819) and other acyl phosphines, 2-methyl-1-(4-methylthio)phenyl-2-(4-morphorlinyl)-1-propanone (available from BASF as IRGACURE 907) and 1-(4-(2-hydroxyethoxy)phenyl)-2-hydroxy-2-methylpropan-1-one (available from BASF as IRGACURE 2959), 2-benzyl 2-dimethylamino 1-(4-morpholinophenyl)butanone-1 (available from BASF as IRGACURE 369), 2-hydroxy-1-(4-(4-(2-hydroxy-2-methylpropionyl)-benzyl)-phenyl)-2-methylpropan-1-one (available from BASF as IRGACURE 127), 2-dimethylamino-2-(4-methylbenzyl)-1-(4-morpholin-4-ylphenyl)-butanone (available from BASF as IRGACURE 379), titanocenes, isopropylthioxanthone, 1-hydroxy-cyclohexylphenylketone, 2,4,6-trimethylbenzophenone, 4-methylbenzophenone, 2,4,6-trimethylbenzoylphenylphosphinic acid ethyl ester, oligo(2-hydroxy-2-methyl-1-(4-(1-methylvinyl)phenyl)propanone), 2-hydroxy-2-methyl-1-phenyl-1-propanone, benzyl-dimethylketal, isopropyl-9H-thioxanthen-9-one, alpha amino ketone (IRGACURE 379), and the like, as well as mixtures thereof.

Optionally, the curable inks can also contain an amine synergist, which are co-initiators which can donate a hydrogen atom to a photoinitiator and thereby form a radical species that initiates polymerization, and can also consume dissolved oxygen, which inhibits free-radical polymerization, thereby increasing the speed of polymerization. Examples of suitable amine synergists include (but are not limited to) ethyl-4-dimethylaminobenzoate, 2-ethylhexyl-4-dimethylaminobenzoate, and the like, as well as mixtures thereof.

Initiators for inks disclosed herein can absorb radiation at any desired or effective wavelength, in one embodiment at least about 200 nanometers, and in one embodiment no more than about 560 nanometers, and in another embodiment no more than about 420 nanometers, although the wavelength can be outside of these ranges.

The initiator can be present in the ink in any desired or effective amount, in one embodiment at least about 0.5% by weight of the carrier, and in another embodiment at least about 1% by weight of the carrier, and in one embodiment no more than about 15% by weight of the carrier, and in another embodiment no more than about 10% by weight of the carrier, although the amount can be outside of these ranges.

The radiation curable inks can also optionally contain an antioxidant. The optional antioxidants can protect the images from oxidation and can also protect the ink components from oxidation during the heating portion of the ink preparation process. Specific examples of suitable antioxidant stabilizers include (but are not limited to) NAUGARD® 524, NAUGARD® 635, NAUGARD® A, NAUGARD® I-403, and NAUGARD® 959, commercially available from Chemtura Corporation, Philadelphia, Pa.; IRGANOX® 1010 and IRGASTAB® UV 10, commercially available from BASF; GENORAD 16 and GENORAD 40 commercially available from Rahn AG, Zurich, Switzerland, and the like, as well as mixtures thereof. When present, the optional antioxidant is present in the ink in any desired or effective amount, in one embodiment at least about 0.01% by weight of the carrier, in another embodiment at least about 0.1% by weight of the carrier, and in yet another embodiment at least about 1% by weight of the carrier, and in one embodiment no more than about 20% by weight of the carrier, in another embodiment no more than about 5% by weight of the carrier, and in yet another embodiment no more than about 3% by weight of the carrier, although the amount can be outside of these ranges.

The inks further contain carbon-coated magnetic nanoparticles. The coated magnetic nanoparticles comprise a core magnetic nanoparticle coated on the surface with a carbon coating material. The coated magnetic nanoparticles can be produced to have different shapes, such as oval, cubic, spherical, hexagonal, or the like, but other shapes are also suitable. Elongated nanoparticles, such as needle or rods-like nanoparticles, are suitable as well. Platelet-shaped, acicular, columnar, octahedral, dodecahedral, tubular, cubical, hexagonal, oval, spherical, dendritic, prismatic, and amorphous shapes are also suitable. An amorphous shape is defined in the context of the present inks as an ill-defined shape having recognizable shape. For example, an amorphous shape has no clear edges or angles. Mixtures of shapes can also be used.

Examples of suitable magnetic nanoparticles include magnetic metallic nanoparticles and ferromagnetic nanoparticles that include, for example, cobalt and iron (cubic), among others. Others include manganese, nickel, and alloys made of all of the foregoing. Additionally, the magnetic nanoparticles can be bimetallic or trimetallic, or a mixture thereof. Examples of suitable bimetallic magnetic nanoparticles include, without limitation, CoPt, fcc (face-centered cubic) phase FePt, fct (face-centered tetragonal) phase FePt, FeCo, MnAl, MnBi, mixtures thereof, and the like. Examples of trimetallic nanoparticles can include, without limitation tri-mixtures of the above magnetic nanoparticles, or core/shell structures that form trimetallic nanoparticles such as Co-covered fct phase FePt.

The magnetic core of the nanoparticles can be prepared by any method known in the art, including ball-milling attrition of larger particles (a common method used in nano-sized pigment production), followed by annealing. The annealing step is generally used because ball milling produces amorphous nanoparticles, which are then subsequently crystallized into the single crystal form. The nanoparticles can also be made directly by RF plasma. Appropriate large-scale RF plasma reactors are available from Tekna Plasma Systems (Sherbrooke, Québec). Metallic Fe nanoparticles can be prepared according to, for example, the methods taught by Watari et al., “Effect of Crystalline Properties on Coercive Force in Iron Acicular Fine Particles,” J. Materials Sci., 23, 1260-1264 (1988); Shah et al., “Effective Magnetic Anisotropy and Coercivity in Fe Nanoparticles Prepared by Inert Gas Condensation,” Int. J. of Modern Phys. B., Vol. 20 (1), 37-47 (2006); and Bonder et al., “Controlling Synthesis of Fe Nanoparticles with Polyethylene Glycol,” J. Magn. Magn. Mater., 311(2), 658-664 (2007), the disclosures of each of which are totally incorporated herein by reference. The fct phase FePt nanoparticle can be synthesized from the fcc phase FePt nanoparticle, according to, for example, the methods taught by Elkins et al., “Monodisperse Face-Centred Tetragonal FePt Nanoparticles with Giant Coercivity,” J. Phys. D: Appl. Phys., pp. 2306-09 (2005); Li et al, “Hard Magnetic FePt Nanoparticles by Salt-Matrix Annealing,” J. Appl. Phy., 99, 08E911 (2006); or Tzitios et al., “Synthesis and Characterization of L1₀ FePt Nanoparticles From Pt (Au, Ag)/γ-Fe₂O₃ Core-Shell Nanoparticles,” Adv. Mater., 17, pp. 2188-92 (2005), the disclosures of each of which are totally incorporated herein by reference. The nanoparticles can also be made by a number of in situ methods in solvents, including water.

The carbon coated magnetic nanoparticles can be prepared by any desired or suitable process. For example, the magnetic cores can be coated by a laser evaporation process. In one approach, graphite layer coated nanoparticles such as nickel of diameters between 3 and 10 nanometers can be produced by laser ablation techniques, as disclosed in, for example, Q. Ou, T. Tanaka, M. Mesko, A. Ogino, M. Nagatsu, Diamond and Related Materials, Vol. 17, Issues 4-5, pages 664-8, 2008, the disclosure of which is totally incorporated herein by reference. In a different approach, carbon coated nanoparticles such as iron can be prepared by carbonizing polyvinyl alcohol using iron as a catalyst in hydrogen flow, as disclosed in, for example, Yu Liang An. Et al., Advanced Materials Research, 92, 7, 2010, the disclosure of which is totally incorporated herein by reference. Alternatively, carbon coated nanoparticles such as iron can be prepared by using an annealing procedure. The procedure induces carbonization of a stabilizing organic material, 3-(N,N-dimethyllaurylammonio)propane sulfonate, which is used to stabilize the pre-formed iron nanoparticles. The process is performed under flow of hydrogen to ensure the carbonization process. The carbon shell effectively protects the iron core from oxidation in acidic solutions, as disclosed in, for example, Z. Guo, L. L. Henry, E. J. Podlaha, ECS Transactions, 1 (12) 63-69, 2006), the disclosure of which is totally incorporated herein by reference.

As described above, the metal nanoparticles herein can be ferromagnetic or superparamagnetic. Superparamagnetic nanoparticles have a remanent magnetization of zero after being magnetized by a magnet. Ferromagnetic nanoparticles have a remanent magnetization of greater than zero after being magnetized by a magnet; that is, ferromagnetic nanoparticles maintain a fraction of the magnetization induced by the magnet. The superparamagnetic or ferromagnetic property of a nanoparticle is generally a function of several factors, including size, shape, material selection, and temperature. For a given material, at a given temperature, the coercivity (i.e. ferromagnetic behavior) is maximized at a critical particle size corresponding to the transition from multidomain to single domain structure. This critical size is referred to as the critical magnetic domain size (Dc, spherical). In the single domain range there is a sharp decrease of the coercivity and remanent magnetization when decreasing the particle size because of thermal relaxation. Further decrease of the particle size results in complete loss of induced magnetization because the thermal effects become dominant and are sufficiently strong to demagnetize previously magnetically saturated nanoparticles. Superparamagnetic nanoparticles have zero remanence and coercivity. Particles of a size of about and above the Dc are ferromagnetic. For example, at room temperature, the Dc for iron is about 15 nanometers, for fcc cobalt is about 7 nanometers, and for nickel is about 55 nm. Further, at room temperature, iron nanoparticles having a particle size of 3, 8, and 13 nanometers are superparamagnetic, while iron nanoparticles having a particle size of 18 to 40 nanometers are ferromagnetic. For alloys, the Dc value may change depending on the materials. For further detail, see Burke et al., Chemistry of Materials, pages 4752-4761, 2002, the disclosure of which is totally incorporated herein by reference. For further detail, see U.S. Patent Publication 2009/0321676; B. D. Cullity and C. D. Graham, Introduction to Magnetic Materials, IEEE Press (Wiley), 2^{nd} Ed., 2009, Chapter 11, Fine Particles and Thin Films, pages 359-364; Lu et al. Angew. Chem. Int. Ed. 2007, 46, 1222-444, Magnetic Nanoparticles: Synthesis, Protection, Functionalization and Application, the disclosures of each of which are totally incorporated herein by reference.

The carbon coating on the magnetic nanoparticles contain elemental carbon. Suitable carbon coating materials include amorphous carbon, glassy carbon, graphite, carbon nanofoam, diamond, and the like, as well as mixtures thereof.

The carbon coating on the magnetic nanoparticles can be present in any desired or effective thickness, in one embodiment at least about 0.2 nanometers, in another embodiment at least about 0.5 nm, and in another embodiment at least about 1 nm, and in one embodiment no more than about 100 nm, in another embodiment no more than about 50 nm, and in yet another embodiment no more than about 20 nm, although the coating thickness can be outside of these ranges.

The carbon-coated magnetic nanoparticles can be of any desired or effective average particle diameter, in one embodiment at least about 3 nm, in another embodiment at least about 10 nm, and in another embodiment at least about 20 nm, and in one embodiment no more than about 500 nm, in another embodiment no more than about 300 nm, and in yet another embodiment no more than about 250 nm, although the average particle diameter can be outside of these ranges. Herein, “average” particle size is represented as d₅₀, or defined as the median particle size value at the 50^{th} percentile of the particle size distribution, wherein 50% of the particles in the distribution are greater than the d₅₀ particle size value, and the other 50% of the particles in the distribution are less than the d₅₀ value. Average particle size can be measured by methods that use light scattering technology to infer particle size, such as Dynamic Light Scattering. The particle diameter refers to the length of the particle as derived from images of the particles generated by Transmission Electron Microscopy (TEM) or from Dynamic Light Scattering measurements.

The coercivity of the magnetic nanoparticles can be, for example, in one embodiment at least about 200 Oersteds, in another embodiment at least about 1,000 Oersteds, and in yet another embodiment at least about 10,000 Oersteds, and in one embodiment no more than about 50,000 Oersteds, in another embodiment no more than about 40,000 Oersteds, and in yet another embodiment no more than about 20,000 Oersteds, although the amount can be outside of these ranges.

The magnetic nanoparticle can have a remanence of in one embodiment at least about 20 emu/g, in another embodiment at least about 30 emu/g, and in yet another embodiment at least about 50 emu/g, and in one embodiment no more than about 100 emu/g, in another embodiment no more than about 80 emu/g, and in yet another embodiment no more than about 70 emu/g, although the amount can be outside of these ranges.

The magnetic saturation moment of the magnetic nanoparticles can be, for example, in one embodiment at least about 20 emu/g, in another embodiment at least about 30 emu/g, and in yet another embodiment at least about 50 emu/g, and in one embodiment no more than about 150 emu/g, in another embodiment no more than about 100 emu/g, and in yet another embodiment no more than about 80 emu/g, although the amount can be outside of these ranges.

Carbon coated magnetic nanoparticles are commercially available (for example from Nanoshel Corporation (Wilmington, Del.).

The carbon-coated magnetic nanoparticles are present in the ink in any desired or effective amount, in one embodiment at least about 0.5% by weight of the ink, in another embodiment at least about 5% by weight of the ink, and in yet another embodiment at least about 6% by weight of the ink, and in one embodiment no more than about 30% by weight of the ink, in another embodiment no more than about 10% by weight of the ink, and in yet another embodiment no more than about 8% by weight of the ink, although the amount can be outside of these ranges.

For MICR ink applications, the ink contains ferromagnetic nanoparticles. The ferromagnetic materials exhibit sufficient remanence once exposed to a source of magnetization to generate a MICR-readable signal and have the capability to retain the same over time. Generally, an acceptable level of charge, as set by industry standards, is between 50 and 200 Signal Level Units, with 100 being the nominal value, which is defined from a standard developed by ANSI (the American National Standards Institute). A lesser signal may not be detected by the MICR reading device, and a greater signal may also not give an accurate reading.

Optionally, the inks can contain a colorant in addition to the carbon-coated magnetic nanoparticles. Any desired or effective colorant can be employed, including dyes, pigments, mixtures thereof, and the like, provided that the colorant can be dissolved or dispersed in the ink carrier. Examples of suitable dyes include, but are not limited to, Usharect Blue 86 (Direct Blue 86), available from Ushanti Colour; Intralite Turquoise 8GL (Direct Blue 86), available from Classic Dyestuffs; Chemictive Brilliant Red 7BH (Reactive Red 4), available from Chemiequip; Levafix Black EB, available from Bayer; Reactron Red H8B (Reactive Red 31), available from Atlas Dye-Chem; D&C Red #28 (Acid Red 92), available from Warner-Jenkinson; Direct Brilliant Pink B, available from Global Colors; Acid Tartrazine, available from Metrochem Industries; Cartasol Yellow 6GF, available from Clariant; Carta Blue 2GL, available from Clariant; solvent dyes, including spirit soluble dyes such as Neozapon Red 492 (BASF); Orasol Red G (BASF); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow CGP (BASF); Orasol Black RLP (BASF); Savinyl Black RLS (Clariant); Morfast Black Conc. A (Rohm and Haas); Orasol Blue GN (BASF); Savinyl Blue GLS (Sandoz); Luxol Fast Blue MBSN (Pylam); Sevron Blue 5GMF (Classic Dyestuffs); Basacid Blue 750 (BASF); Neozapon Black X51 [C.I. Solvent Black, C.I. 12195] (BASF); Sudan Blue 670 [C.I. 61554] (BASF); Sudan Yellow 146 [C.I. 12700] (BASF); Sudan Red 462 [C.I. 260501] (BASF); and the like, as well as mixtures thereof.

Pigments are also suitable colorants for the curable inks. Examples of suitable pigments include PALIOGEN Violet 5100 (BASF); PALIOGEN Violet 5890 (BASF); HELIOGEN Green L8730 (BASF); LITHOL Scarlet D3700 (BASF); SUNFAST® Blue 15:4 (Sun Chemical); Hostaperm Blue B2G-D (Clariant); Permanent Red P-F7RK; Hostaperm Violet BL (Clariant); LITHOL Scarlet 4440 (BASF); Bon Red C (Dominion Color Company); ORACET Pink RF (BASF); PALIOGEN Red 3871 K (BASF); SUNFAST® Blue 15:3 (Sun Chemical); PALIOGEN Red 3340 (BASF); SUNFAST® Carbazole Violet 23 (Sun Chemical); LITHOL Fast Scarlet L4300 (BASF); SUNBRITE Yellow 17 (Sun Chemical); HELIOGEN Blue L6900, L7020 (BASF); SUNBRITE Yellow 74 (Sun Chemical); SPECTRA PAC® C Orange 16 (Sun Chemical); HELIOGEN Blue K6902, K6910 (BASF); SUNFAST® Magenta 122 (Sun Chemical); HELIOGEN Blue D6840, D7080 (BASF); Sudan Blue OS (BASF); NEOPEN Blue FF4012 (BASF); PV Fast Blue B2GO1 (Clariant); IRGALITE Blue BCA (BASF); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow DI 355, DI 351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT); PALIOGEN Black L0084 (BASF); Pigment Black K801 (BASF); and carbon blacks such as REGAL 330™ (Cabot), Carbon Black 5250, Carbon Black 5750 (Columbia Chemical), and the like, as well as mixtures thereof.

When present, the optional colorant is present in the ink in any desired or effective amount to obtain the desired color or hue, in one embodiment at least about 0.1% by weight of the ink, and in another embodiment at least about 0.2% by weight of the ink, and in one embodiment no more than about 15% by weight of the ink, and in another embodiment no more than about 8% by weight of the ink, although the amount can be outside of these ranges.

Alternatively, MICR ink lacking a colorant can be printed on a substrate during a first pass, followed by a second pass, wherein a colored ink that is lacking magnetic particles is printed directly over the colored ink, so as to render the colored ink MICR-readable. This end can be achieved through any means known in the art. For example, each ink can be stored in a separate reservoir. The printing system delivers each ink separately to the substrate, and the two inks interact. The inks can be delivered to the substrate simultaneously or consecutively. Any desired or effective colorant can be employed in the ink compositions, including pigments, dyes, mixtures thereof, and the like. The coated magnetic nanoparticles can also, in embodiments, impart some or all of the colorant properties to the ink composition.

The curable inks can also, if desired, contain additives to take advantage of the known functionality associated with such additives. Such additives may include, for example, defoamers, slip and levelling agents, pigment dispersants, and the like, as well as mixtures thereof. The inks can also include additional monomeric or polymeric materials as desired.

Curing of the ink can be effected by exposure of the ink image to actinic radiation at any desired or effective wavelength, in one embodiment at least about 200 nanometers, and one embodiment no more than about 480 nanometers, although the wavelength can be outside of these ranges. Exposure to actinic radiation can be for any desired or effective period of time, in one embodiment for at least about 0.04 second, in another embodiment for at least about 0.2 second, and in yet another embodiment for at least about 1 second, and in one embodiment for no more than about 15 seconds, and in another embodiment for no more than about 10 seconds, although the exposure period can be outside of these ranges. By curing is meant that the curable compounds in the ink undergo an increase in molecular weight upon exposure to actinic radiation, such as (but not limited to) crosslinking, chain lengthening, or the like.

The ink compositions can be prepared by any desired or suitable method. For example, the ink ingredients can be mixed together, followed by heating, to a temperature in one embodiment of at least about 60° C., and in one embodiment of no more than about 100° C., although the temperature can be outside of these ranges, and stirring until a homogeneous ink composition is obtained, followed by cooling the ink to ambient temperature (typically from about 20 to about 25° C.). The inks are solid at ambient temperature.

The inks can be employed in apparatus for direct printing ink jet processes and in indirect (offset) printing ink jet applications. Another embodiment disclosed herein is directed to a process which comprises incorporating an ink as disclosed herein into an ink jet printing apparatus, melting the ink, and causing droplets of the melted ink to be ejected in an imagewise pattern onto a recording substrate. A direct printing process is also disclosed in, for example, U.S. Pat. No. 5,195,430, the disclosure of which is totally incorporated herein by reference. Yet another embodiment disclosed herein is directed to a process which comprises incorporating an ink as disclosed herein into an ink jet printing apparatus, melting the ink, causing droplets of the melted ink to be ejected in an imagewise pattern onto an intermediate transfer member, and transferring the ink in the imagewise pattern from the intermediate transfer member to a final recording substrate. In a specific embodiment, the intermediate transfer member is heated to a temperature above that of the final recording sheet and below that of the melted ink in the printing apparatus. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements. Inks as disclosed herein can also be employed in other hot melt printing processes, such as hot melt acoustic ink jet printing, hot melt thermal ink jet printing, hot melt continuous stream or deflection ink jet printing, and the like. Curable inks as disclosed herein can also be used in printing processes other than hot melt ink jet printing processes.

Any suitable substrate or recording sheet can be employed, including plain papers such as XEROX® 4024 papers, XEROX® Image Series papers, Courtland 4024 DP paper, ruled notebook paper, bond paper, silica coated papers such as Sharp Company silica coated paper, JuJo paper, HAMMERMILL LASERPRINT® paper, and the like, glossy coated papers such as XEROX® Digital Color Gloss, Sappi Warren Papers LUSTROGLOSS®, and the like, transparency materials, fabrics, textile products, plastics, polymeric films, inorganic substrates such as metals and wood, and the like.

Specific embodiments will now be described in detail. These examples are intended to be illustrative, and the claims are not limited to the materials, conditions, or process parameters set forth in these embodiments. All parts and percentages are by weight unless otherwise indicated.

### Example I

Demonstration of Fire Hazard Reduction with Carbon-Coated Particles

A bag of as-received carbon-coated iron nanoparticles obtained from Nanoshel Corporation (Wilmington, Del.), having an average particle diameter of 25 nm, was opened in a glovebox which had first been inerted with argon such that the oxygen and humidity levels were 5 ppm and 5 ppm, respectively, as a safety precaution. No overheating was observed, indicating that no significant oxidation had occurred in the glovebox. Thereafter a small amount of these particles was removed from the glovebox and exposed to air and no fire was started. Larger amounts of these particles were then handled in air for magnetic inks preparations.

For comparison purposes, uncoated iron nanoparticles (50 nm average particle diameter) obtained from MTI Corp. (Richmond, Calif.) were opened in a glovebox under the same conditions. Even under these conditions they instantly became very hot. They were oxidized quickly by the traces of oxygen and water in the argon gas (˜5 ppm each) and essentially lost most of their magnetic remanence property. If opened in air, these pyrophoric materials would have ignited instantly.

### Example II

### Fabrication of a Magnetic Curable Ink

### Part A: Preparation of a Magnetic Ink Concentrate

To an attritor loaded with zirconia shot (1,800 g) was added a propoxylated neopentyl diacrylate curable monomer (SR9003, 57.6 g, obtained from Sartomer Co. Inc., Exton, Pa.) and an acrylic block copolymer (EFKA 4340, 27.4 g, obtained from BASF in methoxypropanol but removed from solvent before use). The resulting mixture was stirred at 200 rpm, after which was added 15 g of carbon-coated iron nanoparticles (obtained from Nanoshel Corporation, Wilmington, Del., having an average particle diameter of 25 nm) over a 1 minute period. This mixture was then stirred for 20 h and then sieved to remove the stainless steel shot to afford 40 g of a 15% dispersion of the carbon-coated iron particles.

### Part B: Fabrication of a Curable Ink

10 g of ink with 13 wt % carbon-coated iron magnetic particles was then prepared by mixing 8.73 g of the 15 wt % magnetic iron nanoparticles, 0.5 g dipentaerythritol pentaacrylate curable monomer (SR399LV, obtained from Sartomer Corporation), 0.3 g IRGACURE 379 photoinitiator (2-(4-methylbenzyl)-2-(dimethylamino)-1-(4-morpholinophenyl)butan-1-one, obtained from BASF Corporation, Wilmington, Del.), 0.1 g IRGACURE 819 photoinitiator (bis(2,4,6-trimethylbenzoyl)-phenylphosphineoxide, obtained from BASF Corporation), 0.35 g IRGACURE 127 photoinitiator (2-hydroxy-1-{4-[4-(2-hydroxy-2-methyl-propionyl)-benzyl]-phenyl}-2-methyl-propan-1-one, obtained from BASF Corporation), and 0.02 g IRGASTAB UV10 (in-can nitroxide-based stabilizer, obtained from BASF Corporation). The resulting mixture was stirred in a glass bottle at 85° C. for 2 h.

Drops of the ink thus prepared were placed on paper and cured by passing the ink-coated paper under a 600W Fusions UV Lighthammer lamp fitted with a mercury D-bulb at a belt speed of 32 feet per minute. A skin was visible on the surface of the droplets, indicating that curing had taken place.

The paper with the cured drops of the magnetic UV curable ink was attracted by a magnet, indicating that the process for ink fabrication and curing was compatible with the magnetic ink and that the carbon-coated magnetic particles maintained their magnetic properties after curing.

### Example III

The process of Example II is repeated except that the carbon-coated iron nanoparticles have an average particle size of 5 nm instead of 25 nm and that these particles are superparamagnetic. It is believed that the ink will be attracted to a magnetic but that it will lose its magnetization once the magnet is removed.

### Example IV

The process of Example II is repeated except that the carbon-coated nanoparticles have a cobalt core instead of an iron core. It is believed that similar results will be observed.

### Example V

The process of Example II is repeated except that the carbon-coated nanoparticles have a nickel core instead of an iron core. It is believed that similar results will be observed.

### Example VI

The process of Example II is repeated except that the carbon-coated nanoparticles have a MnBi core instead of an iron core. It is believed that similar results will be observed.

### Example VII

The process of Example II is repeated except that the carbon-coated nanoparticles have a Co-covered fct phase FePt core instead of an iron core. It is believed that similar results will be observed.

### Example VIII

The process of Example II is repeated except that the carbon-coated nanoparticles have a manganese core instead of an iron core. It is believed that similar results will be observed.

### Example IX

The process of Example II is repeated except that the carbon-coated nanoparticles have an iron-nickel core instead of an iron core. It is believed that similar results will be observed.

### Example X

The process of Example II is repeated except that the carbon-coated nanoparticles have a fcc phase FePt core instead of an iron core. It is believed that similar results will be observed.

### Example XI

The process of Example II is repeated except that the carbon-coated nanoparticles have a fct phase FePt core, prepared as disclosed in, for example, Li et al., Journal of Applied Physics, 99, 08E911 (2006), the disclosure of which is totally incorporated herein by reference, instead of an iron core. It is believed that similar results will be observed.

### Example XII

A UV curable ink is prepared as described in Ink Example 1 of U.S. Pat. No. 7,754,779, the disclosure of which is totally incorporated herein by reference, by admixing 8.58 g propoxylated neopentyl glycol diacrylate (Sartomer SR 9003), 1.65 g amine modified polyether acrylate (BASF PO 83 F), 0.55 g 2-benzyl 2-dimethylamino 1-(4-morpholinophenyl)butanone-1 (BASF IRGACURE 369), and, instead of the red dye, 1.2 g of carbon coated cobalt nanoparticles of an average particle size of 28 nm available from Nanoshel Corporation, Wilmington, Del. is substituted. It is believed that a magnetic ultraviolet-curable ink will be obtained that is suitable for jetting from a phase change ink jet printer and that will yield images readable by MICR detectors, such as automatic check processors, and otherwise detectable by magnetic ink detectors.

### Example XIII

A radiation curable gel UV ink is prepared as follows: 10 g of the 15% magnetic iron nanoparticles ink concentrate from Example II, Part A is mixed with 0.3 g IRGACURE 379 photoinitiator (2-(4-methylbenzyl)-2-(dimethylamino)-1-(4-morpholinophenyl)butan-1-one, available from BASF Corporation, Wilmington, Del.), 0.1 g IRGACURE 819 photoinitiator (bis(2,4,6-trimethylbenzoyl)-phenylphosphineoxide, available from BASF Corporation), 0.35 g IRGACURE 127 photoinitiator (2-hydroxy-1-{4-[4-(2-hydroxy-2-methyl-propionyl)-benzyl]-phenyl}-2-methyl-propan-1-one, available from BASF Corporation), and 0.02 g IRGASTAB UV10 (in-can nitroxide-based stabilizer, available from BASF Corporation), 0.91 g of a gellant prepared as described in Example 3 of U.S. application Ser. No. 12/765,148 having the formula

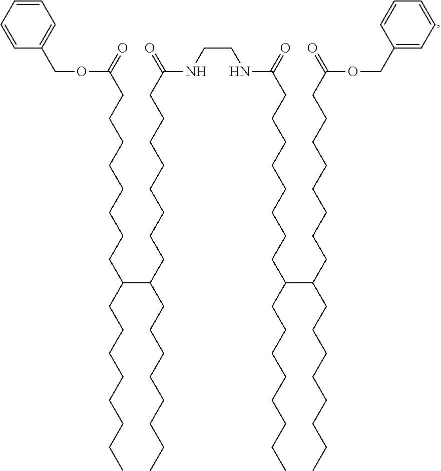

and 0.62 g of UNILIN 350 wax (available from Baker Petrolite). The resulting mixture is stirred in a glass bottle at 85° C. for 2 h. It is believed that this process will provide about 10.8 g of curable gel UV magnetic ink having about 12% by weight carbon coated iron nanoparticles.

### Example XIV

A radiation curable gel UV ink is prepared as described in Example II of U.S. Pat. No. 7,153,349, the disclosure of which is totally incorporated herein by reference, containing propoxylated neopentyl glycol diacrylate (SR9003), amine-modified polyether acrylate (PO 94F), IRGACURE 369, DAROCUR ITX, IRGACURE 819, and a gelator of the formulae

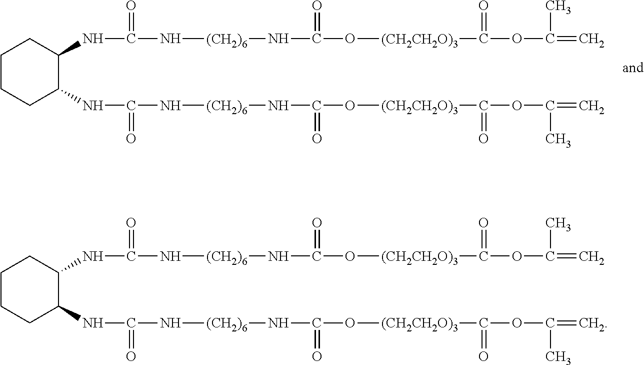

However, instead of the blue pigment described in the patent, an amount of carbon-coated iron pigment particles (25 nm average particle diameter, available from Nanoshel Corporation, Wilmington, Del.) is substituted. The amount of carbon coated nanoparticles is such as to provide an ink containing about 10% carbon coated nanoparticles. It is believed that a magnetic ultraviolet-curable gel ink will be obtained that is suitable for jetting from a phase change ink jet printer and that will yield images readable by MICR detectors, such as automatic check processors, and otherwise detectable by magnetic ink detectors.

### Example XV

A radiation curable ink is prepared as described in Ink Example A of U.S. Pat. No. 7,714,040, the disclosure of which is totally incorporated herein by reference, containing 6.32% by weight of a compound of the formula

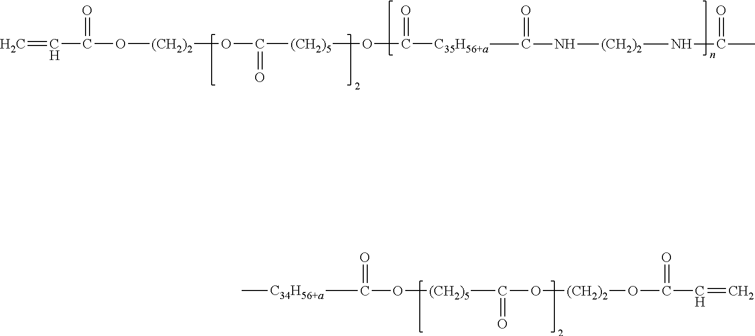

wherein —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12 and n is 1, including (but not limited to) isomers of the formula

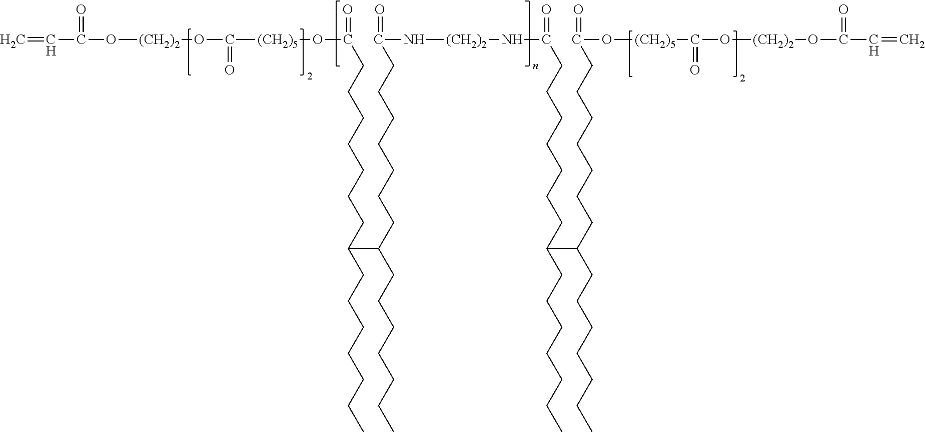

wherein n=1, 2% by weight of isopropyl-9H-thioxanthen-9-one (ITX, obtained from BASF Corporation), 3% by weight of alpha amino ketone (IRGACURE 379, available from BASF Corporation), 3% by weight of 1-[4-2-hydroxyethoxy-phenyl]-2-hydroxy-2-methyl-1-propane-1-one (photoinitiator; IRGACURE 2959, available from BASF Corporation), 0.2% by weight of IRGASTAB UV10 (photoinitiator; available from BASF Corporation), 77.98% by weight of propoxylated neopentyl glycol diacrylate (SR9003, available from Sartomer Co. Inc.), and, instead of the 7.5% by weight of blue pigment dispersion, 7.5% by weight of the magnetic pigment dispersion prepared for the ink of Example II. It is believed that a magnetic ultraviolet-curable gel ink will be obtained that is suitable for jetting from a phase change ink jet printer and that will yield images readable by MICR detectors, such as automatic check processors, and otherwise detectable by magnetic ink detectors.

### Example XVI

7.5 wt. % of an amide gellant of the formula

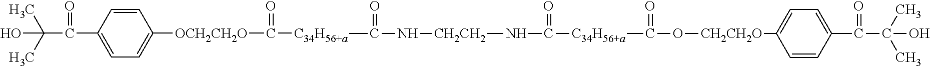

prepared as described in Example I of U.S. Pat. No. 7,625,956, the disclosure of which is totally incorporated herein by reference, is mixed with 70.8 wt. % propoxylated neopentyl glycol diacrylate (SR9003, available from Sartomer Co. Inc., Exton, Pa.), 3.0 wt. % 2-dimethylamino-2-(4-methylbenzyl)-1-(4-morpholin-4-ylphenyl)-butanone (IRGACURE® 379, available from BASF Corporation), 2.0 wt. % isopropyl-9H-thioxanthen-9-one (DAROCUR® ITX, available from BASF Corporation), 1.0 wt. % bis(2,4,6-trimethylbenzoyl)-phenyl-phosphine oxide (IRGACURE® 819, available from BASF Corporation), 3.5 wt. % 2-hydroxy-1-(4-(4-(2-hydroxy-2-methylpropionyl)-benzyl)-phenyl)-2-methylpropan-1-one (IRGACURE® 127, available from BASF Corporation), and 0.2 wt. % IRGASTAB® UV10 (available from BASF Corporation) and stirred for 1 h at 90° C. The resulting solution is added dropwise to 12 wt. % of a stirring solution of the magnetic pigment dispersion prepared for the ink of Example II, also at 90° C. The ink thus prepared is allowed to stir for 1 h further at 90° C. It is believed that a magnetic ultraviolet-curable gel ink will be obtained that is suitable for jetting from a phase change ink jet printer and that will yield images readable by MICR detectors, such as automatic check processors, and otherwise detectable by magnetic ink detectors.

Other embodiments and modifications of the present invention may occur to those of ordinary skill in the art subsequent to a review of the information presented herein; these embodiments and modifications, as well as equivalents thereof, are also included within the scope of this invention.

The recited order of processing elements or sequences, or the use of numbers, letters, or other designations therefor, is not intended to limit a claimed process to any order except as specified in the claim itself.

What is claimed is:

1. A curable magnetic ink comprising:
(a) an ink carrier which comprises at least one curable monomer, oligomer, or prepolymer;
(b) at least one initiator; and
(c) carbon-coated magnetic nanoparticles;
said ink being curable upon exposure to radiation.

2. An ink according to claim 1 wherein the ink is curable upon exposure to ultraviolet radiation.

3. An ink according to claim 1 wherein the curable monomer is propoxylated neopentyl diacrylate, isobornyl acrylate, isobornyl methacrylate, lauryl acrylate, lauryl methacrylate, isodecylacrylate, isodecylmethacrylate, caprolactone acrylate, 2-phenoxyethyl acrylate, isooctylacrylate, isooctylmethacrylate, butyl acrylate, polyester acrylate, pentaerythritol tetraacrylate, pentaerythritol tetramethacrylate, propoxylated neopentylglycol diacrylate, 1,2-ethylene glycol diacrylate, 1,2-ethylene glycol dimethacrylate, 1,6-hexanediol diacrylate, 1,6-hexanediol dimethacrylate, alkoxylated hexanediol diacrylate, tricyclodecane dimethanol diacrylate, 1,12-dodecanol diacrylate, 1,12-dodecanol dimethacrylate, tris(2-hydroxy ethyl)isocyanurate triacrylate, hexanediol diacrylate, tripropylene glycol diacrylate, dipropylene glycol diacrylate, an amine modified polyether acrylate, trimethylolpropane triacrylate, glycerol propoxylate triacrylate, dipentaerythritol pentaacrylate, dipentaerythritol hexaacrylate, ethoxylated pentaerythritol tetraacrylate, or mixtures thereof.

4. An ink according to claim 1 further comprising a gellant.

5. An ink according to claim 4 wherein the gellant is (a) of the formula 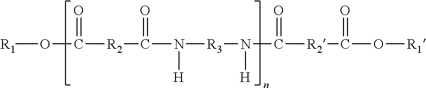
wherein R₁ and R₁′ each, independently of the other, are alkyl, arylalkyl, or alkylaryl, R₂ and R₂′ each, independently of the other, are alkylene, arylene, arylalkylene, or alkylarylene, R₃ is alkylene, arylene, arylalkylene, or alkylarylene, and n is an integer representing the number of repeat amide units; (b) of the formula 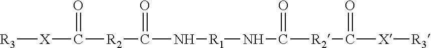
wherein R₁ is alkylene, arylene, arylalkylene, or alkylarylene, R₂ and R₂′ each, independently of the other, are alkylene, arylene, arylalkylene, or alkylarylene, R₃ and R₃′ each, independently of the other, are either photoinitiating groups or alkyl, aryl, arylalkyl, or alkylaryl, provided that at least one of R₃ and R₃′ is a photoinitiating group, and X and X′ each, independently of the other, is an oxygen atom or a group of the formula —NR₄—, wherein R₄ is hydrogen, alkyl, aryl, arylalkyl, or alkylaryl; (c) of the formula 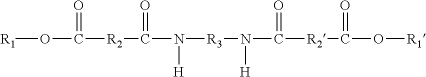
wherein R₁ and R₁′ can be the same or different and wherein R₁ and R₁′ each, independently of the other, are 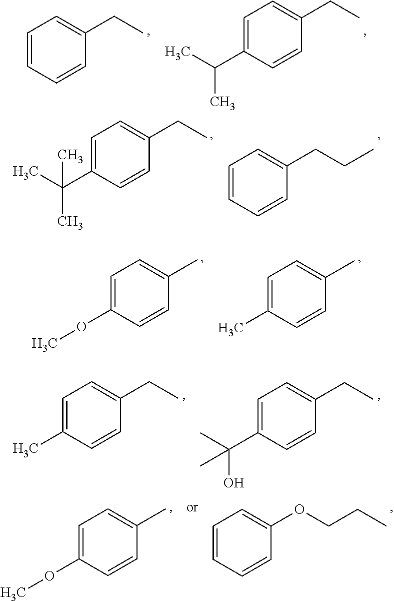
R₂ and R₂′ are branched alkylene groups of the formula —C₃₄H₅₆₊ₐ— which may include unsaturations and cyclic groups, wherein a is an integer of 0, 1, 2, 3, 4, 5, 6, 7, 8, 9, 10, 11, or 12, and R₃ is —CH₂CH₂—; or (d) of the formula 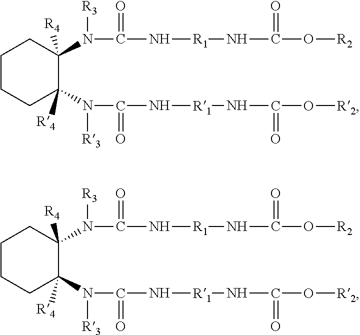
or mixtures thereof, wherein R₁ and R′₁ each, independently of the other, is alkylene, arylene, arylalkylene, or alkylarylene, R₂ and R′₂ each, independently of the other, is alkyl, aryl, arylalkyl, or alkylaryl, R₃ and R′₃ each, independently of the other, is hydrogen or alkyl, R₄ and R′₄ each, independently of the other, is hydrogen, fluorine, alkyl, or phenyl, n is an integer of 0, 1 2, 3, or 4, and each R₅, independently of the others, is alkyl, aryl, arylalkyl, alkylaryl, or a substituent other than an alkyl, aryl, arylalkyl, or alkylaryl.

6. An ink according to claim 4 wherein the gellant is present in an amount of from about 5 to about 50% by weight of the ink carrier.

7. An ink according to claim 1 further comprising a wax.

8. An ink according to claim 1 further comprising a curable wax.

9. An ink according to claim 8 wherein the curable wax comprises the reaction product of a compound of the formula CH₃—(CH₂)ₙ—CH₂OH wherein n is an integer representing the number of repeat CH₂ groups with acrylic acid or methacrylic acid.

10. An ink according to claim 1 wherein the carbon-coated magnetic nanoparticles have a core which comprises (i) iron, (ii) cobalt, (iii) nickel, (iv) manganese, (v) an alloy of iron, cobalt, nickel, manganese, or a mixture thereof, (vi) CoPt, (vii) fcc phase FePt, (viii) fct phase FePt, (ix) FeCo, MnAl, (x) MnBi, (xi) Co-covered fct phase FePt, or (xii) a mixture of one or more of i through xi.

11. An ink according to claim 1 wherein the carbon coating on the magnetic nanoparticles comprises amorphous carbon, glassy carbon, graphite, carbon nanofoam, diamond, or mixtures thereof.

12. An ink according to claim 1 wherein the carbon coating on the magnetic nanoparticles has a thickness of from about 0.2 nm to about 100 nm.

13. An ink according to claim 1 wherein the carbon-coated magnetic nanoparticles have an average particle diameter of from about 3 nm to about 300 nm.

14. An ink according to claim 1 wherein the carbon-coated magnetic nanoparticles are present in the ink in an amount of from about 0.5 to about 30% by weight.

15. An ink according to claim 1 wherein the carbon-coated magnetic nanoparticles exhibit a coercivity of from about 200 to about 50,000 Oersteds.

16. An ink according to claim 1 wherein the carbon-coated magnetic nanoparticles exhibit a magnetic saturation moment of from about 20 to about 150 emu/g.

17. A curable magnetic ink comprising:
(a) an ink carrier which comprises at least one curable monomer, oligomer, or prepolymer;
(b) at least one initiator; and
(c) carbon-coated magnetic nanoparticles having a core which is (i) iron, (ii) cobalt, (iii) nickel, (iv) manganese, (v) an alloy of iron, cobalt, nickel, manganese, or a mixture thereof, (vi) CoPt, (vii) fcc phase FePt, (viii) fct phase FePt, (ix) FeCo, MnAl, (x) MnBi, (xi) Co-covered fct phase FePt, or (xii) a mixture of one or more of i through xi;
said ink being curable upon exposure to ultraviolet radiation;
said carbon-coated magnetic nanoparticles exhibiting a coercivity of from about 200 to about 50,000 Oersteds;
said carbon-coated magnetic nanoparticles exhibiting a magnetic saturation moment of from about 20 to about 150 emu/g.

18. A process which comprises:
(1) incorporating into an ink jet printing apparatus a curable magnetic ink comprising:
(a) an ink carrier which comprises at least one curable monomer, oligomer, or prepolymer;
(b) at least one initiator; and
(c) carbon-coated magnetic nanoparticles;
said ink being curable upon exposure to radiation;
(2) melting the ink;
(3) causing droplets of the melted ink to be ejected in an imagewise pattern onto a substrate; and
(4) exposing the imagewise pattern to curing radiation.

19. A process according to claim 18 wherein the substrate is a final recording sheet and droplets of the melted ink are ejected in an imagewise pattern directly onto the final recording sheet.

20. A process according to claim 18 wherein the substrate is an intermediate transfer member and droplets of the melted ink are ejected in an imagewise pattern onto the intermediate transfer member followed by transfer of the imagewise pattern from the intermediate transfer member to a final recording sheet.
